(19) United States
(12) Patent Application Publication
(10) Pub. No.: US 2023/0385177 A1
(43) Pub. Date: Nov. 30, 2023

(54) TESTING USING LABELLED RECORDED ALERTS

(71) Applicant: Microsoft Technology Licensing, LLC, Redmond, WA (US)

(72) Inventor: Ron Moshe MARCIANO, Ashqelon (IL)

(21) Appl. No.: 17/824,714

(22) Filed: May 25, 2022

(51) Int. Cl. G06F 11/36

(52) U.S. Cl. CPC G06F 11/3604

(57) ABSTRACT

Computer-implemented testing of subject software using labelled recorded alerts. Each of the labelled recorded alerts specifies one or more testing inputs representing one or more events that previously led to prior software when the alert occurred, and a label indicating whether the alert was a true positive. For each labelled recorded alerts, testing of the subject software is automatically performed by 1) reading the one or more testing inputs of the associated labelled recorded alert, 2) applying the read one or more testing inputs to the subject software, and 3) determining whether a fault arises as a result of the application of the read one or more conditions to the subject software. Thus, a tester did not themselves need to come up with testing inputs to apply. Instead, such testing inputs were automatically obtained from labelled data of prior recorded alerts.

### BACKGROUND

Software testing is the process of evaluating and verifying that software does what it is intended to do. Such testing has the effect of reducing deviations between actual function and intended function (otherwise know as “bugs”) as well as improving performance. In a conventional testing environment, engineers attempt to generate a verity of inputs to the software application.

Such input generation may be particularly challenging if the software itself is complex. Software complexity can make it difficult for even an experienced engineer to imagine all of the different inputs that software could experience, especially for inputs relating to events that rarely or sporadically happen. Even if such events are imagined, the software itself may be so complex that it is difficult to know what inputs to provide to the software, and where to apply those inputs.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments described herein relate to a computer-implemented method for testing subject software using labelled recorded alerts. Each of the labelled recorded alerts specifies one or more testing inputs representing one or more events that previously led to prior software resulting in an alert, and a label indicating whether the alert was a true positive. For each of at least some of the labelled recorded alerts, the subject software is automatically tested by 1) reading the one or more testing inputs of the associated labelled recorded alert, 2) applying the read one or more testing inputs to the subject software, and 3) determining whether a fault arises as a result of the application of the read one or more testing inputs to the subject software.

Thus, a tester did not themselves need to come up with testing inputs to apply. Nor did the tester have to understand the software, or figure out where to apply the testing inputs. Instead, such testing inputs were automatically obtained from labelled recorded alerts, and applied automatically to the subject software.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates an environment that includes software that is subject to testing by a testing component, where the testing component automatically tests the subject software from testing input obtained from labelled alerts generated by prior software, in accordance with embodiments described herein;

FIG. 2 illustrates an example of a labelled recorded alert set that represents an example of content of the testing dataset of FIG. 1, where each labelled recorded alert include testing input(s) and an associated positivity label;

FIG. 3 illustrates a flowchart of a computer-implemented method for testing software, in accordance with the principles described herein;

FIG. 4A illustrates unordered testing input that represents an example of the testing input(s) specified in a labelled recorded alert;

FIG. 4B illustrates ordered testing input that represents an example of the testing input(s) specified in a labelled recorded alert;

FIG. 4C illustrates ordered and timed testing input that represents an example of the testing input(s) specified in a labelled recorded alert;

FIG. 5 illustrates a flowchart of a method for handling a fault in the case of a fault being detected when the testing input(s) is applied to the subject software;

FIG. 6 illustrates a flowchart of a method for handling a fault in the case of no fault being detected when the testing input(s) is applied to the subject software; and

FIG. 7 illustrates an example computing system in which the principles described herein may be employed.

### DETAILED DESCRIPTION

Embodiments described herein relate to a computer-implemented method for testing subject software using labelled recorded alerts. Each of the labelled recorded alerts specifies one or more testing inputs representing one or more events that previously led to prior software resulting in an alert, and a label indicating whether the alert was a true positive and/or false positive. For each of at least some of the labelled recorded alerts, the subject software is automatically tested by 1) reading the one or more testing inputs of the associated labelled recorded alert, 2) applying the read one or more testing inputs to the subject software, and 3) determining whether a fault arises as a result of the application of the read one or more testing inputs to the subject software.

Thus, a tester did not themselves need to come up with testing inputs to apply. Nor did the tester have to understand the software, or figure out where to apply the testing inputs. Instead, such testing inputs were automatically obtained from labelled recorded alerts, and applied automatically to the subject software.

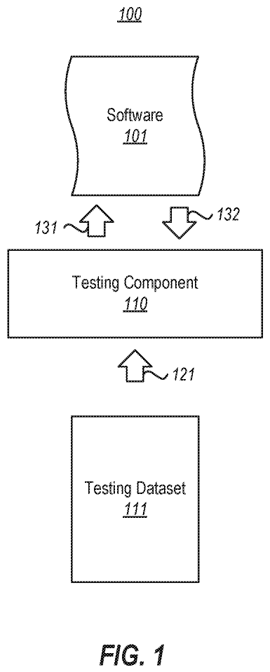

FIG. 1 illustrates an environment 100 that includes software 101 that is being tested (hereinafter also referred to as the “subject software”). The environment 100 also includes a testing component 110 that performs testing upon the subject software 101. In particular, the testing component 110 applies testing inputs to the subject software 101 as represented by arrow 131, and detects resulting testing output of the subject software 101 as represented by arrow 132.

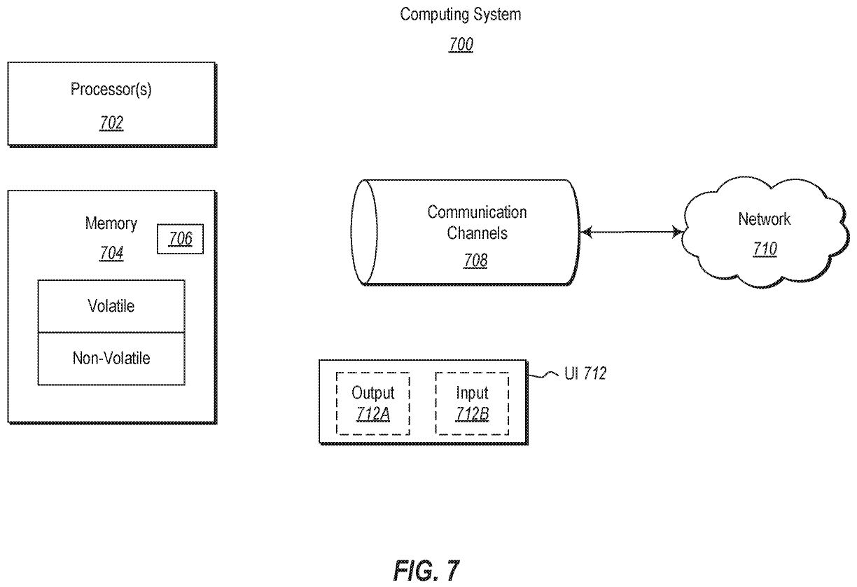

In accordance with the principles described herein, the testing component 110 performs testing at least in part using a testing dataset 111. Thus, as represented by arrow 121, the testing component 110 has access to the testing dataset 111 so as to be able to read the testing dataset 111. If the testing component 110 is implemented in a computing system such as the computing system 700 described below with respect to FIG. 7, then the testing component 110 may be structured as described below for the executable component 706 of FIG. 7.

The testing dataset 111 is composed of multiple labelled recorded alerts that were a result of previous events that led up to alerts being generated by prior software. As an example only, those previous events may be affirmatively testing input applied by a tester to the prior software. Alternatively, or in addition, the previous events may not have been input to the prior software by affirmative testing of the prior software, but may be simply events that occurred in the prior software just prior to an alert being generated. In either case, those previous events will be referred to using the term “testing input” herein as they will be used for testing input in accordance with the principles described herein.

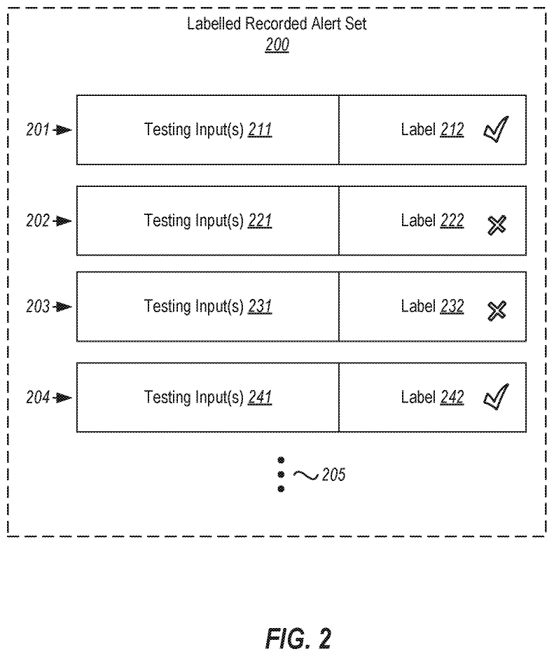

FIG. 2 illustrates an example of a labelled recorded alert set 200 that represents an example of content of the testing dataset 111. In the illustrated example, the labelled recorded alert set 200 includes multiple labelled recorded alerts 201 through 204. Though four labelled recorded alerts are illustrated in FIG. 2, the ellipsis 205 represents that the principles described herein may include any number of labelled recorded alerts. There may even potentially be hundreds, thousands, or an innumerable number of labelled recorded alerts within the labelled recorded alert set 200.

Each of the labelled recorded alert includes one or more testing input(s) that represent events that led up to an alert being generated from the prior software. The testing input may describe the nature of the event and the location in the prior software that the event occurred, such that the testing component can derive how to apply associated testing input to the subject software, and where in the subject software. As an example, if the event is that a particular parameter is set to a particular value, the testing input will note that parameter name, the value to set the parameter to, and where to set the parameter.

In addition, each labelled recorded alert includes a positivity label indicating whether or not the alert was labelled as a true positive and/or a false positive. That determination of whether or not the alert was a true positive may have been previously indicated by a human being (e.g., a testing engineer or even a regular user) in response to encountering the alert that resulted from the application of the testing input represented by the associated testing information. The determination may have alternatively been made by an artificial intelligence.

For example, the labelled recorded alert 201 includes testing input(s) 211 and the positivity label 212. Here, the positivity label 212 includes a checkmark which in the nomenclature of FIG. 2 represents that the positivity label is a “true positive” meaning that the alert was deemed to be a valid alert that should be raised to the attention of the tester. As an example, perhaps the alert signaled a deviation in function or performance of the prior software.

As another example, the labelled recorded alert 202 includes testing input(s) 221 and positivity label 221. Here, the positivity label 222 includes an “X” mark which in the nomenclature of FIG. 2 represents that the positivity label is not a true positive (e.g., is a “false positive”) meaning that the alert was deemed not to represent a deviation in function or performance of the software.

Continuing the example, the recorded alert 203 includes testing input(s) 231 and a positivity label 232 indicating that the alert was not a true positive. Furthermore, the recorded alert 204 includes testing input(s) 241 and positivity label 242 indicating that the alert was a true positive.

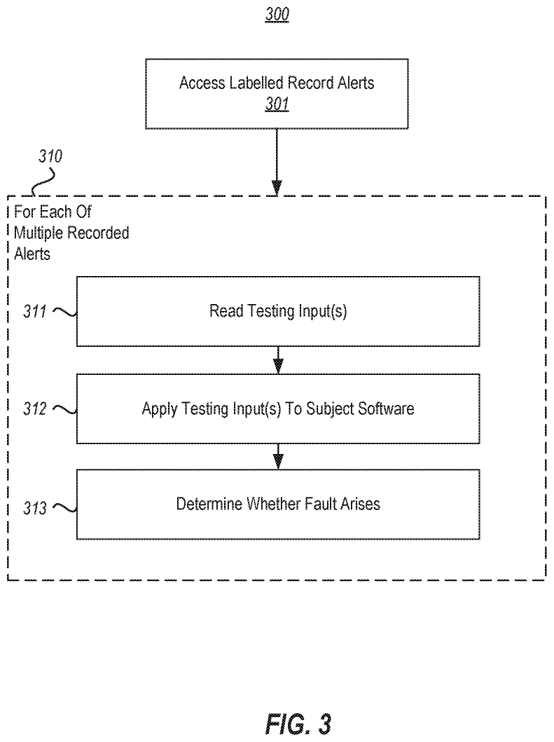

FIG. 3 illustrates a flowchart of a computer-implemented method 300 for testing software, in accordance with the principles described herein. As the method 300 may be performed in the environment 100 of FIG. 1 as an example and by the testing component 110 of FIG. 1, the method 300 of FIG. 3 will now be described with frequent reference to the environment 100 of FIG. 1.

The method 300 includes accessing multiple labelled recorded alerts (act 301). As an example, in FIG. 1, the testing component 110 accesses (as represented by arrow 121) the testing dataset 111. An example of the testing dataset 111 of FIG. 1 is the labelled recorded alert set 200 of FIG. 2. For each of at least some of the labelled recorded alerts, the content of box 310 may be performed for the first labelled recorded alert 201, again for the second labelled recorded alert 202, again for the third labelled recorded alert 203, again for the fourth labelled recorded alert 204, and so on.

For each labelled recorded alert used to test the subject software, the testing component reads the one or more testing inputs of the associated labelled recorded alert (act 311), applies the read one or more testing inputs to the software, (act 312) and determines whether a fault arises as a result of the application of the read one or more testing inputs to the subject software (act 313). For instance, with reference to the first labelled recorded alert 201, the testing component would read the testing input(s) 211, and actually apply those testing input(s) 211 to the subject software. That is, in FIG. 1, the testing component 110 would apply those testing input(s) 211 (as represented by arrow 131) to the subject software 101, and determine from the results (as represented by arrow 132) from the subject software whether a fault has occurred.

Continuing the example, with reference to the second labelled recorded alert 202, the testing component would read the testing input(s) 212, apply those testing input(s) 212 to the subject software, and determine from the results from the subject software whether a fault has occurred. Furthermore, for the third labelled recorded alert 203, the testing component would read the testing input(s) 213, apply those testing input(s) 213 to the subject software, and determine from the results from the subject software whether a fault has occurred. Also, for the fourth labelled recorded alert 204, the testing component would read the testing input(s) 214, apply those testing input(s) 214 to the subject software, and determine from the results from the subject software whether a fault has occurred.

The testing component thus automatically reapplies to the subject software the same events that had previously been led the prior software that resulted in an alert. The prior software whose alerts built the labelled recorded data set should be close enough to the subject software now being tested that the events are still meaningful, and that the place in the subject software where testing input is to be applied can be derived from the place in the prior software that the event occurred. In one embodiment, the prior software is a previous version of the subject software. Accordingly, the events that led up to the alert being generated for the prior version may be replayed to see if an alert is again generated this time from the subject software.

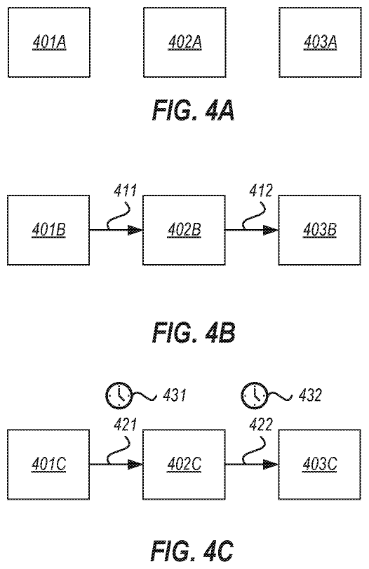

In one example, the testing input may be unordered input. For example, FIG. 4A illustrates an example of three items of testing input 401A, 402A and 403A. This represents an example of the testing input(s) of any of the labelled recorded alerts. As an example, the testing input 400A, 400B and 400C may represent an example of the testing input(s) 211 of FIG. 2. In the case of unordered testing input, the order in which the testing inputs are applied to the subject software does not matter. Accordingly, in this case, the application of the testing input(s) to the subject software (act 312) need not have any ordering.

Alternatively, or in addition, the testing input may be ordered input. For example, FIG. 4B illustrates an example of three items of testing input 401B, 402B and 403B, where testing input 401G is to be applied first followed by (as represented by arrow 411) testing input 402B followed by (as represented by arrow 412) testing input 403B. In this case, the application of the testing input(s) to the subject software would comprise applying the testing inputs in the represented order.

Alternatively, or in addition, the testing input may be ordered and have an associated timing. As an example, FIG. 4C illustrates an example of three items of testing input 401C, 402C and 403C. Testing input 401C is to be applied first followed by (as represented by arrow 421) the testing input 402C with a particular timing (as represented by clock 431). Testing input 402C is followed by (as represented by arrow 422) the testing input 403C with a particular timing (as represented by clock 432). The timing need not be the same timing at which events occurred leading up to the alert being generated for the prior software. For instance, if there were two events that occurred five days apart that led up to an alert for the prior software, it may be that a lesser timing may suffice to suitably replay the sequence of events. That is, the previously generated alert might not be dependent on the timing of the later event being greater than a certain amount of time.

The testing input(s) also may be combinations of FIGS. 4A through 4C with some testing inputs perhaps having no dependencies, with some testing inputs having ordering dependencies, and with some testing inputs having ordering and timing dependencies. Furthermore, although a particular order is shown as a simple sequence in FIGS. 4B and 4C, more complex graphs of dependencies may also be described in the testing input(s). The ordering and timing dependencies are applied when applying the testing input(s) to the subject software.

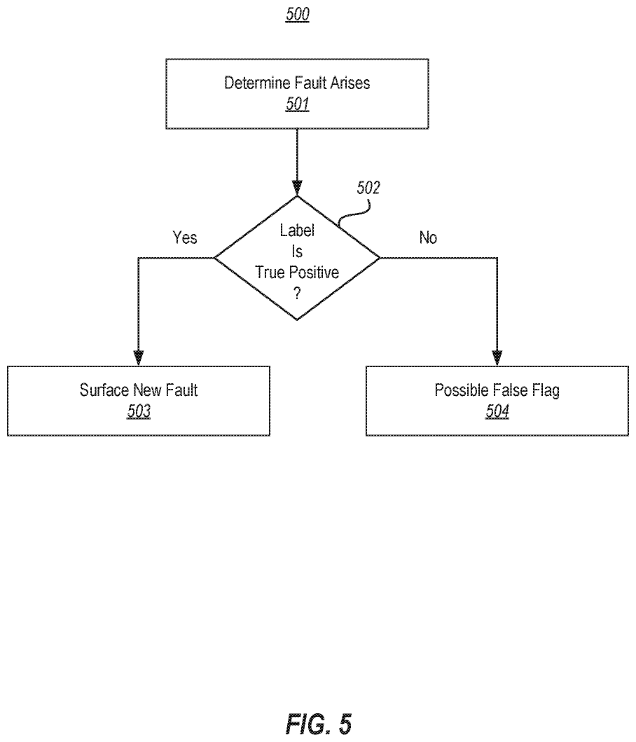

FIG. 5 illustrates a flowchart of a method 500 for handling a fault in the case of a fault being detected when the testing input(s) is applied to the subject software (or in other words when act 313 of FIG. 3 results in a fault being detected). The method 500 includes determining that a fault arises (act 501). How the fault is processed depends on whether the label of the associated labelled recorded alert indicates that the prior alert was a true positive (decision block 502).

If the prior alert was a true positive (“Yes” in decision block 502), this means that the subject software, like the prior software, continues to have a fault. Accordingly, a new fault is surfaced in the form of a new alert (act 503). On the other hand, if the prior alert was not a true positive (“No” in decision block 502), then the currently detected fault in the subject software may be a false flag (act 504). Possible actions in that case could include creating an alert, but with a potential false flag message, or perhaps even abstaining from surfacing the fault in the form of a new alert at all. The test may be kept to evaluate future changes in the software.

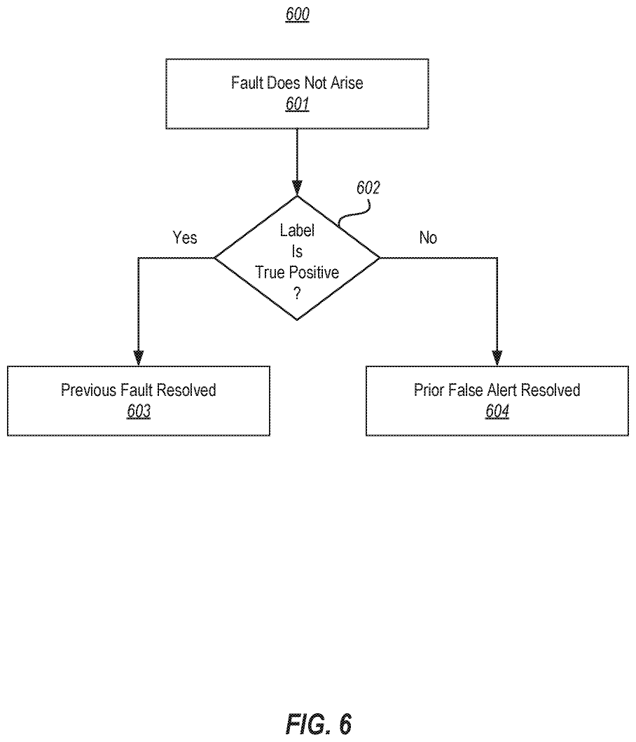

FIG. 6 illustrates a flowchart of a method 600 for responding to there being no fault in the case of no fault being detecting when the testing input(s) is applied to the subject software (or in other words when act 313 of FIG. 3 results in no fault being detected). The method 600 includes determining that no fault arises (act 601). How the lack of a fault is processed depends on whether the label of the associated labelled recorded alert indicates that the prior alert was a true positive (decision block 602).

If the prior alert was a true positive (“Yes” in decision block 602), this means that the subject software has likely resolved the fault (act 603) that was present in the prior software. Appropriate actions in that case might be to present a prior fault resolved message to the user, or perhaps not notifying the user of anything at all. On the other hand, if the prior alert was not a true positive (“No” in decision block 602), then it would then appear that the testing process no longer raises an alert when it previously raised an alert when there was no real fault (act 604). Possible actions in that case could include letting the user know that the testing software no longer raises a false alert, or perhaps not taking any further action at all. The test may be kept to evaluate future changes in the software.

Accordingly, the principles described herein provide a mechanism for harvesting prior alerts issued with respect to the operation of prior software as new testing inputs for current software. This potentially allows for more rare or sporadic cases to be tested for than might otherwise be imagined by a tester who manually tests the software. Accordingly, the testing of software is improved. Furthermore, even the mere application of testing input to the software may be burdensome and time consuming if the software is complex. Accordingly, the principles described herein allow for the automation of testing or supplementation of manual testing with automated testing of software, where edge cases are more likely tested for, and testing is more efficient for complex software.

Because the principles described herein are performed in the context of a computing system, some introductory discussion of a computing system will be described with respect to FIG. 7. Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 7, in its most basic configuration, a computing system 700 includes at least one hardware processing unit 702 and memory 704. The processing unit 702 includes a general-purpose processor. Although not required, the processing unit 702 may also include a field programmable gate array (FPGA), an application specific integrated circuit (ASIC), or any other specialized circuit. In one embodiment, the memory 704 includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

The computing system 700 also has thereon multiple structures often referred to as an “executable component”. For instance, the memory 704 of the computing system 700 is illustrated as including executable component 706. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 704 of the computing system 700. Computing system 700 may also contain communication channels 708 that allow the computing system 700 to communicate with other computing systems over, for example, network 710.

While not all computing systems require a user interface, in some embodiments, the computing system 700 includes a user interface system 712 for use in interfacing with a user. The user interface system 712 may include output mechanisms 712A as well as input mechanisms 712B. The principles described herein are not limited to the precise output mechanisms 712A or input mechanisms 712B as such will depend on the nature of the device. However, output mechanisms 712A might include, for instance, speakers, displays, tactile output, virtual or augmented reality, holograms and so forth. Examples of input mechanisms 712B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, if executed by the one or more processors, the computing system would be configured to test subject software by being configured to perform the following:
accessing a plurality of labelled recorded alerts, each of the labelled recorded alerts specifying one or more testing inputs representing one or more events that previously led to prior software resulting in an alert and a label indicating whether the alert was a true positive; and
for each of at least some of the plurality of labelled recorded alerts, testing the subject software by performing the following:
reading the one or more testing inputs of the associated labelled recorded alert;
applying the read one or more testing inputs to the subject software; and
determining whether a fault arises as a result of the application of the read one or more testing inputs to the subject software.

2. The computing system in accordance with claim 1, the one or more computer-readable instructions being further structured such that, if executed by the one or more processors, and if the one or more testing inputs of a labelled recorded alert of the plurality of labelled recorded alerts is a sequence of testing inputs in an order, the applying of the read one or more testing inputs to the subject software comprises applying the sequence of testing inputs to the subject software in the order.

3. The computing system in accordance with claim 1, the one or more computer-readable instructions being further structured such that, if executed by the one or more processors, and if the one or more testing inputs of a labelled recorded alert of the plurality of labelled recorded alerts is a timed sequence of testing inputs in an order and timing, the applying of the read one or more testing inputs to the subject software comprises applying the sequence of testing inputs to the subject software in the order and with the timing.

4. The computing system in accordance with claim 1, the one or more computer-readable instructions being further structured such that, if executed by the one or more processors, and if the one or more testing inputs of a labelled recorded alert of the plurality of labelled recorded alerts is a sequence of testing inputs in an order and a timing between two testing inputs, the applying of the read one or more testing inputs to the subject software comprises applying the sequence of testing inputs to the subject software in the order and with the timing between the two testing inputs.

5. The computing system in accordance with claim 1, the one or more computer-readable instructions being further structured such that, if executed by the one or more processors, and if a fault arises as a result of the application of the read one or more testing inputs of a particular labelled recorded alert to the subject software, the computing system is caused to create a new fault if a label of the particular labelled recorded alert is a true positive.

6. The computing system in accordance with claim 5, the particular labelled recorded alert being a first particular labelled recorded alert, the one or more computer-readable instructions being further structured such that, if executed by the one or more processors, and if a fault arises as a result of the application of the read one or more testing inputs of a second particular labelled recorded alert to the subject software, the computing system is caused to create a potential false flag alert if a label of the second particular labelled recorded alert is not a true positive.

7. The computing system in accordance with claim 1, the one or more computer-readable instructions being further structured such that, if executed by the one or more processors, and if a fault arises as a result of the application of the read one or more testing inputs of a particular labelled recorded alert to the subject software, the computing system is caused to create a potential false flag alert if a label of the particular labelled recorded alert is not a true positive.

8. The computing system in accordance with claim 1, the one or more computer-readable instructions being further structured such that, if executed by the one or more processors, and if a fault arises as a result of the application of the read one or more testing inputs of a particular labelled recorded alert to the subject software, the computing system is caused to block the fault from being raised to a tester if a label of the particular labelled recorded alert is not a true positive.

9. The computing system in accordance with claim 1, the one or more computer-readable instructions being further structured such that, if executed by the one or more processors, and if a fault does not arise as a result of the application of the read one or more testing inputs of a particular labelled recorded alert to the subject software, the computing system is caused to raise a potential testing error message if a label of the particular labelled recorded alert is a true positive.

10. The computing system in accordance with claim 1, the prior software being a previous version of the subject software.

11. A computer-implemented method for testing subject software, the method comprising:
accessing a plurality of labelled recorded alerts, each of the labelled recorded alerts specifying one or more testing inputs representing one or more events that previously led to prior software resulting in an alert and a label indicating whether the alert was a true positive; and
for each of at least some of the plurality of labelled recorded alerts, testing the subject software by performing the following:
reading the one or more testing inputs of the associated labelled recorded alert;
applying the read one or more testing inputs to the subject software; and
determining whether a fault arises as a result of the application of the read one or more testing inputs to the subject software.

12. The method in accordance with claim 11, if the one or more testing inputs of a labelled recorded alert of the plurality of labelled recorded alerts is a sequence of testing inputs in an order, the applying of the read one or more testing inputs to the subject software comprises applying the sequence of testing inputs to the subject software in the order.

13. The method in accordance with claim 11, if the one or more testing inputs of a labelled recorded alert of the plurality of labelled recorded alerts is a timed sequence of testing inputs in an order and a timing between two testing inputs, the applying of the read one or more testing inputs to the subject software comprises applying the sequence of testing inputs to the software in the order and with the timing between the two testing inputs.

14. The method in accordance with claim 11, the prior software being a previous version of the subject software.

15. The method in accordance with claim 11, the determining whether a fault arises as a result of the application of the read one or more testing inputs to the subject software comprising for a particular labelled recorded alert, determining that a fault does arise as a result of the application of the read one or more testing inputs of the particular labelled recorded alert, the method further comprising:
determining that a label of the particular labelled recorded alert is a true positive; and
in response to determining that the label of the particular labelled recorded alert is a true positive, creating a new fault.

16. The method in accordance with claim 15, the particular labelled recorded alert being a first particular labelled recorded alert, the determining whether a fault arises as a result of the application of the read one or more testing inputs to the subject software for a second particular labelled recorded alert comprising determining that a fault does arise as a result of the application of the read one or more testing inputs of the second particular recorded alert to the subject software, the method further comprising:
determining that a label of the second particular labelled recorded alert is not a true positive; and
in response to determining that the label of the second particular labelled recorded alert is not a true positive, creating a potential false flag alert.

17. The method in accordance with claim 11, the determining whether a fault arises as a result of the application of the read one or more testing inputs to the subject software comprising for a particular labelled recorded alert, determining that no fault arises as a result of the application of the read one or more testing inputs of the particular labelled recorded alert, the method further comprising:
determining that a label of the particular labelled recorded alert is a true positive; and
in response to determining that the label of the particular labelled recorded alert is a not a true positive alert, creating a potential resolved flag.

18. The method in accordance with claim 11, the determining whether a fault arises as a result of the application of the read one or more testing inputs to the subject software comprising for a particular labelled recorded alert, determining that a fault arises as a result of the application of the read one or more testing inputs of the particular labelled recorded alert, the method further comprising:
determining that a label of the particular labelled recorded alert is not a true positive; and
in response to determining that the label of the particular labelled recorded alert is not a true positive position, blocking the fault from being raised to a tester.

19. The method in accordance with claim 11, the determining whether a fault arises as a result of the application of the read one or more testing inputs to the subject software comprising for a particular labelled recorded alert, determining that a fault does not arise as a result of the application of the read one or more testing inputs of the particular labelled recorded alert, the method further comprising:
determining that a label of the particular labelled recorded alert is a true positive; and
in response to determining that the label of the particular labelled recorded alert is a true positive, creating a potential testing error message.

20. A computer program product comprising one or more computer-readable storage media having thereon computer-executable instructions that are structured such that, if executed by one or more processors of a computing system, would cause the computing system to be configured perform the following acts for testing subject software:
accessing a plurality of labelled recorded alerts, each of the labelled recorded alerts specifying one or more testing inputs representing one or more events that previously led to prior software resulting in an alert and a label indicating whether the alert was a true positive; and
for each of at least some of the plurality of labelled recorded alerts, testing the subject software by performing the following:
reading the one or more testing inputs of the associated labelled recorded alert;
applying the read one or more testing inputs to the subject software; and
determining whether a fault arises as a result of the application of the read one or more testing inputs to the subject software.
